(19) United States
(12) Patent Application Publication
(10) Pub. No.: US 2009/0207132 A1
(43) Pub. Date: Aug. 20, 2009

(54) DISPLAY DEVICE, IMAGE FEEDING DEVICE, DISPLAY SYSTEM, PROGRAM, AND INFORMATION STORAGE MEDIUM

(75) Inventor: Hiroyuki ICHIEDA, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/364,234

(22) Filed: Feb. 2, 2009

(30) Foreign Application Priority Data
Feb. 8, 2008 (JP) 2008-028459

(51) Int. Cl. G09G 5/00; H04N 3/24

(52) U.S. Cl. 345/156; 348/E03.047

(57) ABSTRACT

A display device includes: a mute deciding unit that decides whether mute designation for an image has been changed; a displaying side communication unit that receives image information from an image feeding device and that if the mute designation has been changed from invalidation to validation, transmits suspension-of-feed instructing information to the image feeding device; and a displaying side display unit that displays an image on the basis of the image information and that if the mute designation has been changed from invalidation to validation, ceases display of the image.

The present application encompasses the contents of Japanese Patent Application No. 2008-28459 filed on Feb. 8, 2008.

### BACKGROUND OF THE INVENTION

1. Technical Field

The present invention relates to an image display device, an image feeding device, a display system, a program, and an information storage medium.

2. Related Art

As described in, for example, JP-A-2006-58668, a personal computer (PC) may transmit image information on an image, which is displayed on the PC, to a projector over a network, and the projector may display the same image as the image displayed on the PC. By the way, a projector having a mute designation function for tentatively ceasing display of an image is available (refer to, for example, JP-A-2006-58668 and JP-A-2003-280087).

While a display device such as a projector is receiving image information from an image feeding device such as a PC, even if mute designation is set to validation in the display device, the image feeding device proceeds with transmission of the image information, and the display device proceeds with reception of the image information and rendering of an image based on the image information. Therefore, an unnecessary processing load is generated in the display device and image feeding device alike.

In the JP-A-2003-280087, a projector that when mute designation is validated, decreases an output luminance of a lamp and lowers a rotating speed of a fan is described. Since the projector controls the output luminance and rotating speed by itself, no consideration is taken into such an unnecessary processing load.

### SUMMARY

The first aspect of the present invention relates to a display device characterized by inclusion of:

a mute deciding unit that decides whether mute designation for an image has been changed;

a displaying side communication unit that receives image information from an image feeding device and that if the mute designation has been changed from invalidation to validation, transmits suspension-of-feed instructing information to the image feeding device; and

a displaying side display unit that displays an image on the basis of the image information and that if the mute designation has been changed from invalidation to validation, ceases display of the image.

The second aspect relates to an image feeding device characterized by inclusion of:

a feeding side communication unit that transmits image information to a display device and that if mute designation for an image in the display device has been changed from invalidation to validation, receives suspension-of-feed instructing information from the display device; and

an instruction deciding unit that decides whether the suspension-of-feed instructing information has been received and that if the suspension-of-feed instructing information has been received, ceases transmission of the image information to the feeding side communication unit.

The second aspect relates to a display system including the display device and image feeding device.

### BRIEF DESCRIPTION OF THE SEVERAL VIEWS OF THE DRAWING

FIG. 1 is a functional block diagram of a projector in the present embodiment.

FIG. 2 is a functional block diagram of a PC in the present embodiment.

FIG. 3 is a flowchart presenting a processing procedure in the PC in the present embodiment.

FIG. 4 is a flowchart presenting a processing procedure in the projector in the present embodiment.

### DETAILED DESCRIPTION OF THE EMBODIMENT

According to the present invention, there can be provided a display device capable of reducing a processing load when mute designation is changed, an image feeding device, a display system, a program, and an information storage medium.

A display device in accordance with the present invention is characterized by inclusion of: a mute deciding unit that decides whether mute designation for an image has been changed; a displaying side communication unit that receives image information from an image feeding device and that if the mute designation has been changed from invalidation to validation, transmits suspension-of-feed instructing information to the image feeding device; and a displaying side display unit that displays an image on the basis of the image information and that if the mute designation has been changed from invalidation to validation, ceases display of the image.

A program in accordance with the present invention causes a computer, which is included in a display device having a displaying side communication unit and a displaying side display unit, to function as: a mute deciding unit that decides whether mute designation for an image has been changed; a displaying side communication control unit that controls the displaying side communication unit so that: the displaying side communication unit will receive image information from an image feeding device; and if the mute designation has been changed from invalidation to validation, the displaying side communication unit will transmit suspension-of-feed instructing information to the image feeding device; and a displaying side display control unit that controls the displaying side display unit so that: the displaying side display unit will display an image on the basis of the image information; and if the mute designation has been changed from invalidation to validation, the displaying side display unit will cease display of the image.

According to the present invention, the display device can reduce a processing load to be imposed on the display device in case mute designation is changed from invalidation to validation. By transmitting suspension-of-feed instructing information to the image feeding device, a processing load on the image feeding device can also be reduced.

If the mute designation has been changed from validation to invalidation, the displaying side communication unit transmits resumption-of-feed instructing information to the image feeding device. Based on the image information transmitted from the image feeding device on the basis of the resumption-of-feed instructing information, the displaying side display unit may resume display of the image.

Accordingly, even when the processing of reducing a processing load in case mute designation is changed from invalidation to validation is executed, if the mute designation has been changed from validation to invalidation, the display device can quickly resume display of an image.

If the mute designation has been changed from invalidation to validation, the displaying side display unit may release a rendering hardware resource. If the mute designation has been changed from validation to invalidation, the displaying side display unit may preserve the rendering hardware resource.

Accordingly, the display device can reduce a processing load to be imposed on the display device incurs in case mute designation is changed from invalidation to validation. In addition, when the mute designation is canceled, the display device can quickly resume display of an image.

If the mute designation has been changed from invalidation to validation and transmission of image information from the image feeding device continues, the displaying side communication unit receives the image information, but the displaying side display unit may not perform the display of the image based on the image information.

For example, when mute designation is changed from invalidation to validation, if the display device discontinues reception of image information, error information or the like may be transmitted to the image feeding device and a processing load on the image feeding device may be increased. In contrast, according to the present constitution, when the mute designation is changed from invalidation to validation, if the display device continues reception of image information, error information or the like is not transmitted to the image feeding device. The processing load on the image feeding device is therefore not increased. As long as display of an image based on the image information is not carried out, the processing load on the display device can be reduced.

An image feeding device in accordance with the present invention is characterized by inclusion of: a feeding side communication unit that transmits image information to a display device and that if mute designation for an image in the display device has been changed from invalidation to validation, receives suspension-of-feed instructing information from the display device; and an instruction deciding unit that decides whether the suspension-of-feed instructing information has been received and that if the suspension-of-feed instructing information has been received, allows the feeding side communication unit to cease transmission of the image information.

A display system in accordance with the present invention is characterized by inclusion of the display device and image feeding device.

A program in accordance with the present invention causes a computer, which is included in an image feeding device having a feeding side communication unit, to function as: a feeding side communication control unit that allows the feeding side communication unit to transmit image information to a display device and that if mute designation for an image in the display device has been changed from invalidation to validation, allows the feeding side communication unit to receive suspension-of-feed instructing information from the display device; and an instruction deciding unit that decides whether the suspension-of-feed instructing information has been received and that if the suspension-of-feed instructing information has been received, allows the feeding side communication unit to cease transmission of the image information.

An information storage medium in accordance with the present invention is an information storage medium in which a program readable by a computer included in an image feeding device having a feeding side communication unit is stored. The foregoing program is stored in the information storage medium.

According to the present invention, when mute designation in a display device is changed from invalidation to validation, an image feeding device receives suspension-of-feed instructing information and ceases transmission of image information. Thus, the image feeding device can reduce a processing load to be imposed thereon.

The image feeding device includes: a feeding side display unit that displays an image; and a capture unit that captures at least part of the image in a rendering memory so as to produce image information which represents at least part of the image. If the suspension-of-feed instructing information has been received, the instruction deciding unit may allow the capture unit to cease capture of the image.

Accordingly, when mute designation in the display device is changed from invalidation to validation, if the image feeding device ceases capture of an image, the image feeding device can reduce a processing load to be imposed thereon.

When image information is transmitted initially or when feed of the image information is resumed, the instruction deciding unit allows the capture unit to produce image information which represents the whole of the image in the rendering memory. When transmission of the image information is not initial transmission and feed of the image information is not resumed, the instruction deciding unit may allow the capture unit to produce image information representing an image of an area which has changed compared with the one stored in the rendering memory at the previous time of rendering.

Accordingly, the image feeding device can normally reduce a processing load for communication by transmitting image information which represents an image of a changed area. Assuming that feed of image information is ceased, when feed of the image information is resumed, if image information that represents an entire image stored in the rendering memory is transmitted, an appropriate image can be displayed on a display device.

An embodiment in which the present invention is applied to a display system including a projector and a PC will be described with reference to the drawings. The embodiment to be described below does not restrict the contents of the present invention set forth in Claims. All constituent features described below in relation to the embodiment are not always essential as pieces of solving means of the present invention set forth in Claims.

The display system includes a projector that is a sort of display device and a PC that is a sort of image feeding device. The PC captures an image being displayed on the PC, and transmits image information, which represents the whole or part of the image, to the projector over a transmission line (which may be a wireless transmission line or a wired transmission line). The projector receives the image information from the PC and projects the image based on the image information. If mute designation for an image has been changed from invalidation to validation, the projector ceases projection of the image and suspends feed (transmission) of the image information to the PC.

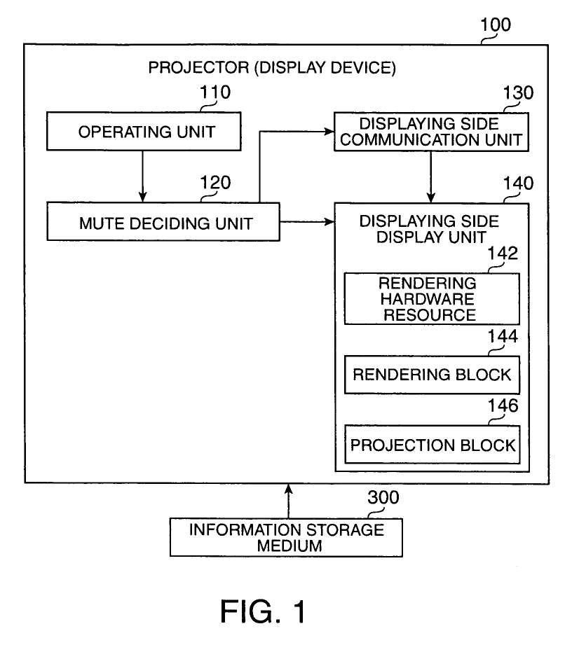

Next, the functional blocks of the projector having the foregoing function will be described below. FIG. 1 is a functional block diagram of a projector 100 in the present embodiment. The projector 100 includes: an operating unit 110; a mute deciding unit 120 that decides based on manipulative information, which is sent from the operating unit 110, whether mute designation for an image has been changed; a displaying side communication unit 130 that receives image information from a PC and that if mute designation has been changed from invalidation to validation, transmits suspension-of-feed instructing information to the PC; and a displaying side display unit 140 that displays an image on the basis of the image information and that if mute designation has been changed from invalidation to validation, ceases display of the image.

The displaying side display unit 140 includes a rendering hardware resource 142, a rendering block 144, and a projection block 146. The rendering block 144 uses the rendering hardware resource 142 to render an image on a liquid crystal panel of the projection block 146.

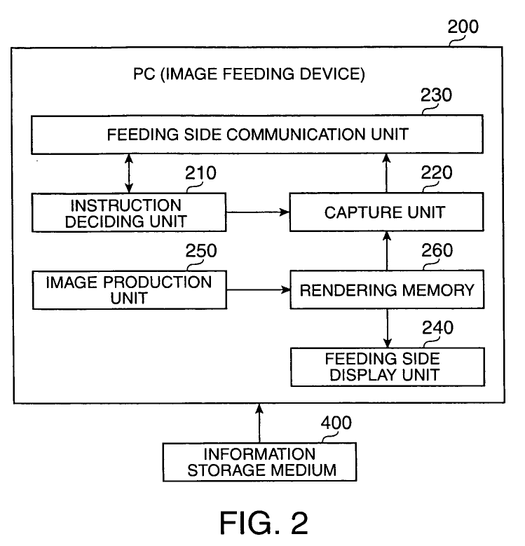

Next, the functional blocks of the PC will be described below. FIG. 2 is a functional block diagram of the PC 200 in the present embodiment. The PC 200 includes: a feeding side communication unit 230 that transmits image information to the projector 100 and that if mute designation for an image in the projector 100 has been changed from invalidation to validation, receives suspension-of-feed instructing information from the projector 100; and an instruction deciding unit 210 that decides whether the suspension-of-feed instructing information has been received and that if the suspension-of-feed instructing information has been received, ceases transmission of image information to the feeding side communication unit 230.

The PC 200 includes a rendering memory 260, an image production unit 250 that produces an image in the rendering memory 260, a capture unit 220 that captures the whole or part of the image in the rendering memory 260 and that produces image information representing the captured image, and a feeding side display unit 240 that displays the image produced in the rendering memory 260.

The capture unit 220 compares an entire image, which is produced in the rendering memory 260 within an immediately preceding frame (for example, an n-1 frame where n denotes an integer equal to or larger than 2) with an entire image, which is produced in the rendering memory 260 within a current frame (for example, an n frame), and produces image information representing an image of an area that has changed (changed area). In the case of initial feed or when feed is resumed, the capture unit 220 captures the whole of the image in the rendering memory 260 so as to produce image information representing the entire image. In the case of the second or subsequent feed, the capture unit 220 produces image information representing the image of the changed area. The rendering memory 260 has a capacity large enough to store pieces of image information for at least two frames.

The foregoing units may be mounted using, for example, hardware described below. For example, buttons, a remote controller, and others may be adopted as the operating unit 110. A CPU, a RAM, and others may be adopted as the mute deciding unit 120 or instruction deciding unit 210. A wire communication unit, a radiocommunication unit, or the like may be adopted as the displaying side communication unit 130 or feeding side communication unit 230. A VRAM, a scaler, or the like may be adopted as the rendering hardware resource 142 or rendering memory 260. An image processing circuit or the like may be adopted as the rendering block 144 or image production unit 250. A lamp, a liquid crystal panel, a liquid crystal drive circuit, a projection lens, and others may be adopted as the projection block 146. An image processing circuit, a VRAM, and others may be adopted as the capture unit 220. A liquid crystal display may be adopted as the feeding side display unit 240.

The projector 100 may have the facility of the mute deciding unit 120 or the like installed therein by reading a program stored in an information storage medium 300. The PC 200 may have the facility of the instruction deciding unit 210 or the like installed therein by reading a program stored in an information storage medium 400. As the information storage medium 300 or 400, for example, a CD-ROM, a DVD-ROM, a ROM, a RAM, an HDD, or the like may be adopted. A method of reading the program may be a contact method or a non-contact method.

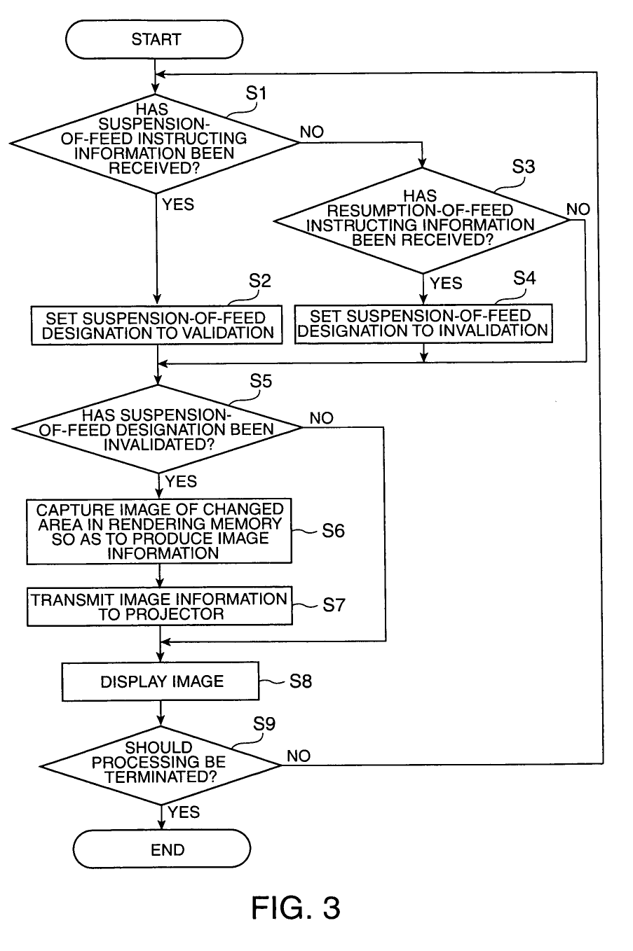

Next, an image processing procedure using the foregoing units will be described below. FIG. 3 is a flowchart presenting the processing procedure in the PC 200 in the present embodiment.

The instruction deciding unit 210 of the PC 200 decides whether suspension-of-feed instructing information has been received by the feeding side communication unit 230 (step S1), and decides whether resumption-of-feed instructing information has been received by the feeding side communication unit 230 (step S3).

If neither of the pieces of instructing information has been received, the instruction deciding unit 210 decides whether suspension-of-feed designation specified in a flag, a register, or the like is invalidated, that is, the current state of the PC 200 is not a feed suspended state (step S5). If suspension-of-feed instructing information has been received, the instruction deciding unit 210 sets the suspension-of-feed designation to validation (step S2). If resumption-of-feed instructing information has been received, the instruction deciding unit 210 sets the suspension-of-feed designation to invalidation (step S4).

To be more specific, for example, if suspension-of-feed instructing information has been received, the instruction deciding unit 210 updates an internal suspension-of-feed designation flag to validation (for example, sets the flag value to 1). If resumption-of-feed instructing information has been received, the instruction deciding unit 210 updates the internal suspension-of-feed designation flag to invalidation (for example, sets the flag value to 0).

When suspension-of-feed designation is invalidated, the capture unit 220 captures an image of a changed area in the rendering memory 260 in which an image is produced by the image production unit 250, and produces image information (step S6). As for a concrete technique of detecting the change area, since the technique is described in JP-A-2006-58668, an iterative description will be omitted.

The feeding side communication unit 230 transmits the image information, which is produced by the capture unit 220, to the projector 100 (step S7). If suspension-of-feed designation is validated, the PC 200 does not execute the pieces of processing of steps S6 and S7.

Irrespective of a decision made by the instruction deciding unit 210, the feeding side display unit 240 displays an image that is produced in the rendering memory 260 by the image production unit 250 (step S8). Specifically, when suspension-of-feed designation is validated, the PC 200 suspends production of image information to be transmitted to the projector 100 and transmission thereof but proceeds with production and display of an image.

By detecting whether the power button of the PC 200 has been turned off, the PC 200 decides whether image processing should be terminated (step S9). For example, if the power button has been turned off, the image processing is terminated. If image processing is not terminated, the PC 200 repeatedly executes the foregoing pieces of processing (steps S1 to S9).

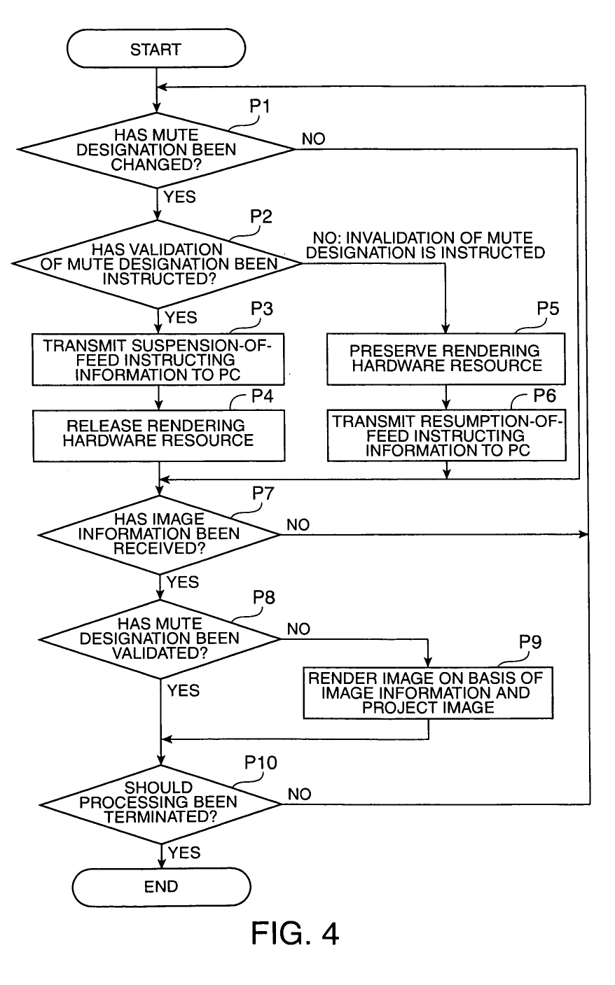

Next, an image processing procedure in the projector 100 will be described below. FIG. 4 is a flowchart presenting the processing procedure in the projector 100 in the present embodiment.

The mute deciding unit 120 decides whether mute designation has been changed (step P1). For example, the mute deciding unit 120 may use an internal state flag to manage mute designation concerning the projector 100. For example, when an internal mute designation flag in the mute deciding unit 120 is retained in an invalidated state, if mute designation is instructed, the mute designation is changed.

If mute designation has been changed, the mute deciding unit 120 decides whether validating the mute designation has been instructed (step P2). If validating the mute designation has been instructed, the displaying side communication unit 130 transmits suspension-of-feed instructing information to the PC 200 in response to the instruction sent from the mute deciding unit 120 (step P3).

If validating mute designation has been instructed, the rendering block 144 releases the rendering hardware resource 142 in response to the instruction sent from the mute deciding unit 120 (step P4). Accordingly, the displaying side display unit 140 can utilize the released rendering hardware resource 142 for various usages including rendering of an on-screen display (OSD) image, and the like.

For example, if a mute button on the main body of the projector 100 has been depressed, if a mute button on the remote controller of the projector 100 has been depressed, of if the cover of the projection lens of the projector 100 has been closed, validating mute designation is instructed using the operating unit 110 or the like.

If mute designation has been changed and validating the mute designation has not been instructed, that is, if invalidating the mute designation has been instructed, the rendering block 144 preserves the rendering hardware resource 142 in response to an instruction sent from the mute deciding unit 120 (step P5). If invalidating the mute designation has been instructed, the displaying side communication unit 130 transmits resumption-of-feed instructing information to the PC 200 in response to the instruction sent from the mute deciding unit 120 (step P6).

The rendering block 144 decides whether image information sent from the PC 200 has been received by the displaying side communication unit 130 (step P7). If the image information has been received, the rendering unit 144 decides based on information sent from the instruction deciding unit 120 whether mute designation has been validated (step P8).

If image information has been received and mute designation has been validated, the rendering block 144 uses the rendering hardware resource 142 to render an image on the liquid crystal panel on the basis of the image information. The projection block 146 projects the image (step P9).

In the present embodiment, image information may not represent an entire image but may represent only a changed area in an image. Therefore, the rendering block 144 may render an image according to, for example, a method of overwriting an original image with the image of the changed area.

The projector 100 detects whether the power button of the projector 100 has been turned off so as to decide whether image processing should be terminated (step P10). For example, if the power button has been turned off, the image processing is terminated. If the image processing is not terminated, the projector 100 repeatedly executes the foregoing pieces of processing (steps P1 to P10).

As mentioned above, according to the present embodiment, the projector 100 can reduce the processing load to be imposed on the projector 100 in case mute designation has been changed from invalidation to validation. In addition, the processing load on the PC 200 can also be reduced by transmitting suspension-of-feed instructing information to the PC 200. Therefore, power savings of the projector 100 and PC 200 alike can be achieved.

According to the present embodiment, when mute designation is invalidated, the projector 100 preserves the rendering hardware resource 142 and transmits resumption-of-feed instructing information to the PC 200. Even when the processing of reducing a processing load in case the mute designation is changed from invalidation to validation is executed, if the mute designation is invalidated, display of an image can be quickly resumed.

According to the present embodiment, when mute designation in the projector 100 is changed from invalidation to validation, if the PC 200 receives suspension-of-feed instructing information and ceases transmission of image information, the PC 200 can reduce the processing load on the PC 200.

According to the present embodiment, when mute designation in the projector 100 is changed from invalidation to validation, if the PC 200 ceases capture of an image, the PC 200 can reduce the processing load on the PC 200. Normally, if the PC 200 transmits image information which represents an image of an area having changed, the PC 200 can reduce the processing load for communication. Even when feed of the image information is ceased, if image information representing an entire image in the rendering memory 260 is transmitted at the time of resumption of feed of the image information, an appropriate image can be displayed on the projector 100.

Application of the present invention is not limited to the aforesaid embodiment but the present invention can be varied in various manners. For example, the display device is not limited to the projector 100, but various types of display devices, for example, a television and a liquid crystal display can be adopted. The image feeding device is not limited to the PC 200, but various types of devices, for example, a portable cellular phone, game equipment, and a DVD player can be adopted.

When mute designation is changed from invalidation to validation, if transmission of image information from the PC 200 is carried on, the displaying side communication unit 130 continues reception of the image information. The displaying side display unit 140 may not perform the display of an image based on the image information.

For example, when mute designation is changed from invalidation to validation, if the projector 100 immediately discontinues reception of image information, error information or the like may be transmitted to the PC 200 and the processing load on the PC 200 may increase. In contrast, according to the present constitution, when the mute designation is changed from invalidation to validation, if the projector 100 continues reception of image information, the error information or the like is not transmitted to the PC 200. The processing load on the PC 200 will not therefore increase. As long as the display of an image based on image information is not carried out, the processing load on the projector 100 can be reduced.

The aforesaid capture unit 220 performs deciding of a changed area, production of image information only on a changed area, or the like. The capture unit may always capture an entire image so as to produce image information. If the display device such as the projector includes an audio output unit, the mute deciding unit decides whether audio mute designation has been changed. If mute designation has been changed from invalidation to validation, the displaying side communication unit 130 transmits suspension-of-feed instructing information to the image (audio) feed device. If the mute designation has been changed from validation to invalidation, the displaying side communication unit 130 transmits resumption-of-feed instructing information to the image (audio) feeding device. If the mute designation has been changed from invalidation to validation, the audio output unit may cease audio output. If the mute designation has been changed from validation to invalidation, the audio output unit may resume audio output.

The projector 100 is not limited to a liquid crystal projector but may be a projector or the like that adopts as a light modulator a liquid crystal on silicon (LCOS) device, a digital micromirror device (DMD), or the like. Incidentally, DMD is a trademark of U.S. Texas Instruments Inc.

The facilities of the projector 100 may be distributed to and mounted in multiple devices (for example, the PC and projector). The facilities of the PC 200 may be distributed to and mounted in multiple devices. For example, the facilities of the image production unit 250 and rendering memory 260 may be included in a DVD player, the facility of the feeding side display unit 240 may be included in a television, and the facilities of the instruction deciding unit 210, capture unit 220, and feeding side communication unit 230 may be included in the PC.

1. A display device comprising:
a mute deciding unit that decides whether mute designation for an image has been changed;
a displaying side communication unit that receives image information from an image feeding device and that if the mute designation has been changed from invalidation to validation, transmits suspension-of-feed instructing information to the image feeding device; and
a displaying side display unit that displays an image on the basis of the image information and that if the mute designation has been changed from invalidation to validation, ceases display of the image.

2. The display device according to claim 1, wherein:
if the mute designation has been changed from validation to invalidation, the displaying side communication unit transmits resumption-of-feed instructing information to the image feeding device; and
based on the image information transmitted from the image feeding device on the basis of the resumption-of-feed instructing information, the displaying side display unit resumes display of the image.

3. The display device according to claim 2, wherein: if the mute designation has been changed from invalidation to validation, the displaying side display unit releases a rendering hardware resource; and if the mute designation has been changed from validation to invalidation, the displaying side display unit preserves the rendering hardware resource.

4. The display device according to claim 1, wherein:
if the mute designation has been changed from invalidation to validation and transmission of the image information from the image feeding device continues, the displaying side communication unit receives the image information but the displaying side display unit does not perform the display of the image based on the image information.

5. An image feeding device comprising:
a feeding side communication unit that transmits image information to a display device and that if mute designation for an image in the display device has been changed from invalidation to validation, receives suspension-of-feed instructing information from the display device; and
an instruction deciding unit that decides whether suspension-of-feed instructing information has been received and that if the suspension-of-feed instructing information has been received, allows the feeding side communication unit to cease transmission of the image information.

6. The image feeding device according to claim 5, further comprising:
a feeding side display device that displays an image; and
a capture unit that captures at least part of the image in a rendering memory so as to produce image information representing at least part of the image, wherein:
if suspension-of-feed instructing information has been received, the instruction deciding unit allows the capture unit to cease capture of the image.

7. The image feeding device according to claim 6, wherein: when the image information is initially transmitted or feed of the image information is resumed, the instruction deciding unit allows the capture unit to produce image information which represents the whole of the image in the rendering memory; when transmission of the image information is not initial transmission or feed of the image information is not resumed, the instruction deciding unit allows the capture unit to produce image information representing an image of an area which has changed compared with the one stored in the rendering memory at the previous time of rendering.

8. A display system including the display device according to claim 1.

9. A program causing a computer, which is included in a display device having a displaying side communication unit and a displaying side display unit, to function as:
a mute deciding unit that decides whether mute designation for an image has been changed;
a displaying side communication control unit that controls the displaying side communication unit so that: the displaying side communication unit will receive image information from an image feeding device; and if the mute designation has been changed from invalidation to validation, the displaying side communication unit will transmit suspension-of-feed instructing information to the image feeding device; and
a displaying side display control unit that controls the displaying side display unit so that: the displaying side display unit will display an image on the basis of the image information; and if the mute designation has been changed from invalidation to validation, the displaying side display unit will cease display of the image.

10. A program causing a computer, which is included in an image feeding device having a feeding side communication unit, to function as:
a feeding side communication control unit that allows the feeding side communication unit to transmit image information to a display device and that if mute designation for an image in the display device has been changed from invalidation to validation, allows the feeding side communication unit to receive suspension-of-feed instructing information from the display device; and
an instruction deciding unit that decides whether the suspension-of-feed instructing information has been received and that if the suspension-of-feed instructing information has been received, allows the feeding side communication unit to cease transmission of the image information.

11. An information storage medium in which a program readable by a computer included in an image feeding device having a feeding side communication unit is stored, wherein the program according to claim 10 is stored in the information storage medium.

12. A display system including the image feeding device according to claim 5.
